(19) United States
(12) Patent Application Publication
(10) Pub. No.: US 2002/0184382 A1
(43) Pub. Date: Dec. 5, 2002

(54) Method and apparatus for the dynamic regulation of resource splitting over a plurality of data streams competing for these resources in a communications network by a dynamic release rate

(76) Inventor: Thomas Engel, Unterbiberg (DE)

Correspondence Address: SCHIFF HARDIN & WAITE, 6600 SEARS TOWER, 233 S WACKER DR, CHICAGO, IL, 60606-6473, US

(21) Appl. No.: 10/100,954

(22) Filed: Mar. 19, 2002

(30) Foreign Application Priority Data
Mar. 21, 2001 (DE) 10113838.5
Dec. 12, 2001 (DE) 10161136.6

(51) Int. Cl. G06F 15/173; G06F 15/16

(52) U.S. Cl. 709/235; 709/226

(57) ABSTRACT

For dynamically regulating resource splitting over a plurality of data streams competing for resources in a communications network, the resources to be split are made available in a resource pool. For each competing data stream, a resource share is taken from this resource pool and is allocated to this data stream, with the resource requirement for a data stream being dynamically aligned on the basis that, if the resource requirement has risen, a correspondingly greater resource share is allocated if possible or resources which are no longer required are returned to the resource pool. In this case, a resource share which is no longer required is returned to the resource pool if the resource share has not been required for a prescribed number of successive resource inquiries or if no new resource inquiries are received for a prescribed time period.

### BACKGROUND OF THE INVENTION

The invention relates to a method and to a corresponding apparatus for the dynamic regulation of resource splitting over a plurality of data streams competing for these resources in a communications network, the resources to be split being made available in a resource pool from which, for each competing data stream, a resource share is taken and is allocated to this data stream.

In the future, IP networks customary today will provide additional transport services which differ significantly from today's quality of service in terms of availability of bandwidth, delay, delay jitter and packet loss rate.

In this context, the abbreviation IP stands for “Internet Protocol”, a protocol of the TCP/IP family on layer 3 of the OSI reference model. IP is responsible for the connectionless transport of data from the sender to the receiver via a plurality of networks, with no error detection or correction being carried out, i.e. IP does not concern itself with defective or lost packets. The central data-carrying unit defined in the IP is the datagram, which can have a length of up to 65535 bytes.

IP is used by a plurality of higher-level protocols, primarily by TCP (Transmission Control Protocol, a connection-oriented transport protocol which allows logical full-duplex point-to-point connection), but also by UDP (User Datagram Protocol, a connectionless application protocol for transporting datagrams of the IP family).

Data to be transferred are received by such protocols above IP and are fragmented by the sender, i.e. are broken down into datagrams. At the receiver end, they are assembled again, which is referred to as defragmentation. IP is independent of the medium used and is equally suitable for LANs (Local Area Networks), WANs (Wide Area Networks) and for mobile networks.

Access to the aforementioned new transport services needs to be protected by admission control (AC). In this case, the problem arises that the transmission resources available in IP networks need to be split over competing transport services and traffic streams. The resources have to be split both over the various transport services and over the competing traffic streams of a transport service which are produced at various network access facilities.

Unfavorable splits result in poor utilization (if a traffic stream is allocated more resources than it requires and these resources are therefore no longer available to others) or in losses of quality which can clearly be felt by the user (high blocking rate, long delays, and finally packet losses if too few resources have been allocated). To make matters worse, the resource requirement is a greatly fluctuating statistical variable which is difficult to estimate.

In telephone networks, this problem is solved by means of “hop-by-hop-AC per call”. Transfer of this solution to IP networks is currently regarded by persons skilled in the art as not being implementable, at least not for large networks.

Currently, intensive work is being carried out throughout the world to develop solutions for resource management for the DiffServ network. In this context, on the basis of the fundamental DiffServ concept, solutions are being sought for splitting the resources within the network over aggregated traffic streams efficiently with little complexity.

The paper “Adaptive Resource Control for QoS Using an IP-based Layered Architecture”, Martin Winter (Editor), EU-Deliverable IST-1999-10077-WP1.2-SAG-1201-PU-0/b0, June 2000, proposes a concept for using “resource pools” to introduce dynamic resource distribution into IP networks.

“An Adaptive Algorithm for Resource Management in a Differentiated Service Network”, E. Nikolouzou, G. Politis, P. Sampatakos, I. S. Venieris, National Technical University of Athens 2000, describes an associated method which carries out the actual resource distribution. In simulations, however, this method has turned out to be difficult to control and not to be robust in the face of overload. The actual aim of automatic resource distribution is therefore not achieved, since the sensitivity of the control parameters to the traffic load means that the administrator needs to observe the method continuously and to set the parameters carefully.

### SUMMARY OF THE INVENTION

An object of the present invention is to provide an opportunity for splitting available resources over a quantity of competing traffic streams and for dynamically aligning this splitting with the respective conditions prevailing.

With the present invention, a method is provided for dynamic regulation of resource splitting over a plurality of data streams competing for these resources in a communications network, the resources to be split being made available in a resource pool from which, for each competing data stream, a resource share is taken and is allocated to this data stream, where

the resource requirement for a data stream is dynamically aligned on the basis that, if the resource requirement has risen, a correspondingly greater resource share is allocated if possible or resources which are no longer required are returned to the resource pool, where

a resource share which is no longer required is returned to the resource pool if the resource share has not been required for a prescribed number of successive resource inquiries or if

no new resource inquiries are received for a prescribed time period.

Advantages and details of the preferred embodiments are revealed on the basis of the advantageous exemplary embodiments described below and in conjunction with the Figures:

### BRIEF DESCRIPTION OF THE DRAWINGS

FIG. 1 shows a detail from a larger IP network which supports various transport services having different qualities of service (QoS);

FIG. 2 shows an example of the activity of a Leaky Share in a resource management system (resource share manager RSM) on the basis of the processing of an AC request;

FIG. 3 shows an example of the activity of a Leaky Share in a resource management system (resource share manager RSM) on the basis of the processing of an AC release;

FIG. 4 shows an example of the activity of a Leaky Share in a resource management system (resource share manager RSM) on the basis of a call to the AC release method when an activated release timer runs out;

FIG. 5 shows a reaction of a resource management system RSM to an AC request; if the share of used resources exceeds the threshold value Wₕ further resources are requested from the RP;

FIG. 6 shows processing of a resource request in a resource pool manager (RPM);

FIG. 7 shows processing of a resource release in a resource pool manager (RPM);

FIG. 8 shows a reaction of a resource management system RSM to an AC release;

FIG. 9 shows an exemplary embodiment of a Retry Filter on the basis of the processing of an AC request in the resource management system RSM;

FIG. 10 shows an example of the activity of the Adaptive Watermark method in a resource management system RSM on the basis of processing of an AC request;

FIG. 11 shows an exemplary embodiment of an Adaptive Retry Filter on the basis of the processing of an AC request in the resource management system RSM;

FIG. 12 shows an example of the activity of an Adaptive Leaky Share in a resource management system RSM on the basis of the processing of an AC request;

FIG. 13 shows the basis of the processing of an AC release for the activity of an Adaptive Leaky Share;

FIG. 14 shows a call to the AC release method for the activity of an Adaptive Leaky Share when an activated release timer runs out; and

FIG. 15 shows processing of a timeout for a release timer in the RSM.

### DESCRIPTION OF THE PREFERRED EMBODIMENTS

For the purposes of promoting an understanding of the principles of the invention, reference will now be made to the preferred embodiments illustrated in the drawings and specific language will be used to describe the same. It will nevertheless be understood that no limitation of the scope of the invention is thereby intended, such alterations and further modifications in the illustrated device, and/or method, and such further applications of the principles of the invention as illustrated therein being contemplated as would normally occur now or in the future to one skilled in the art to which the invention relates.

In the preferred embodiment, the resources do not need to be made available in, taken from or returned to a resource pool physically. That is merely the viewpoint of resource management. The resource pool is used for managing the resources which are in shared use by all competitors.

It has been found to be advantageous if the prescribed time period is proportioned such that the prescribed number of successive resource inquiries could be expected therein.

In addition, one advantageous embodiment is distinguished in that if the resource requirement has risen, an allocated resource share is increased, provided that there are still other resources available in the resource pool, or otherwise

further attempts to increase a resource share are prevented until a second prescribed number of successive resource inquiries has been received. Otherwise, as an alternative,

further attempts to increase a resource share can be prevented until a prescribed time period has elapsed.

In this context, it can be advantageous if the first and second prescribed numbers of successive resource inquiries adopt the same value.

Another advantageous embodiment of the invention is distinguished in that

a time profile is ascertained for the resource requirement of the data stream and is compared with a prescribed threshold value, where

the associated resource share is increased if there are still other resources available in the resource pool

as soon as the resource requirement reaches or exceeds the threshold value. On the basis of another advantageous embodiment,

a resource share which is no longer required is returned to the resource pool only if

upon return there is no drop below a prescribed minimum value for the resource share.

In addition, in an embodiment, a resource management system is provided. Such an apparatus achieves the following features:

a resource pool for making available resources which are to be split and from which, for each competing data stream (RPS), a resource share can be taken and can be allocated to this data stream, where

a system for dynamically aligning the resource requirement for a data stream is provided which can be used, if the resource requirement has increased, to allocate a correspondingly greater resource share if possible or to return resources which are no longer required to the resource pool, where

a resource share which is no longer required can be returned to the resource pool if

the resource share has not been required for a prescribed number of successive resource inquiries or if

no new resource inquiries are received for a prescribed time period.

One advantageous embodiment is that the system for dynamically aligning the resource requirement can proportion the prescribed time period such that the prescribed number of successive resource inquiries could be expected therein.

An embodiment can be improved further by virtue of the system for dynamically aligning the resource requirement

being able to increase an allocated resource share when the resource requirement has risen, provided that there are still other resources available in the resource pool, or otherwise

being able to prevent further attempts to increase a resource share until a second prescribed number of successive resource inquiries has been received.

One alternative embodiment is distinguished in that, otherwise,

further attempts to increase a resource share (RS) can be prevented until a prescribed time period has elapsed.

Another recommendation is for the means for dynamically aligning the resource requirement

to be able to ascertain a time profile for the resource requirement of the data stream and to be able to compare it with a prescribed threshold value, where

the allocated resource share can be increased if there are still other resources available in the resource pool

as soon as the resource requirement reaches or exceeds the threshold value.

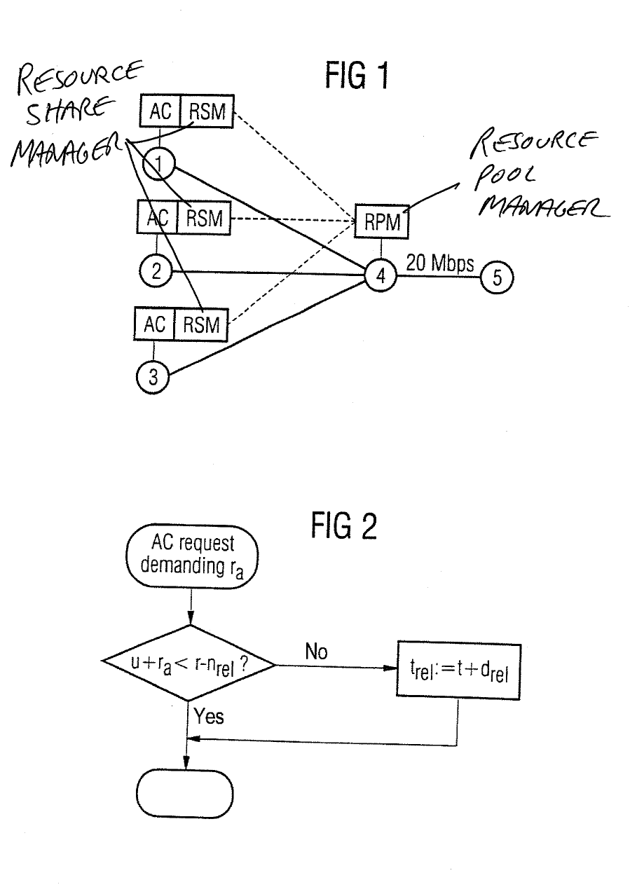

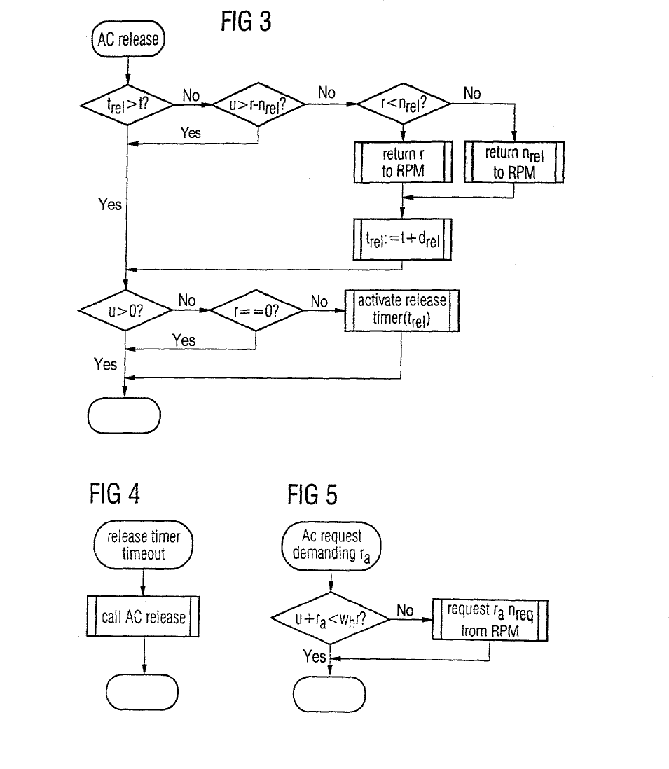

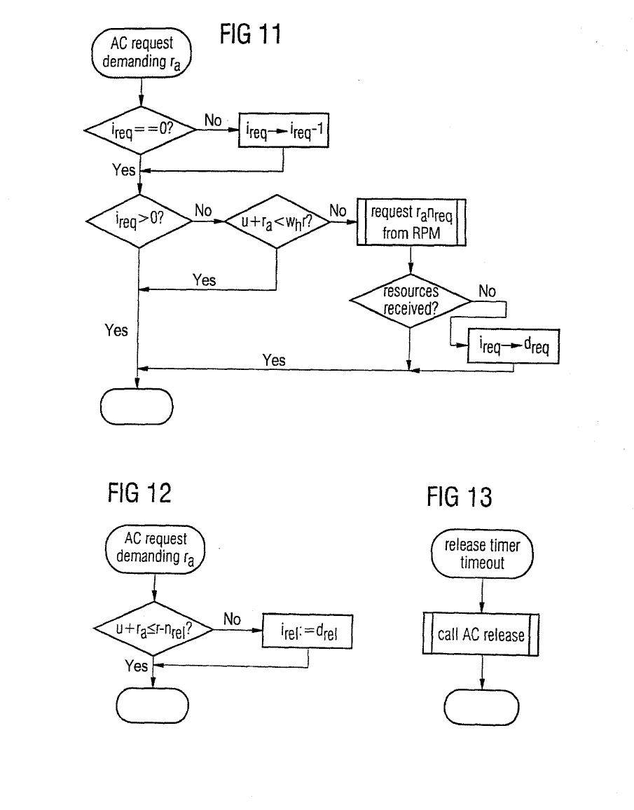

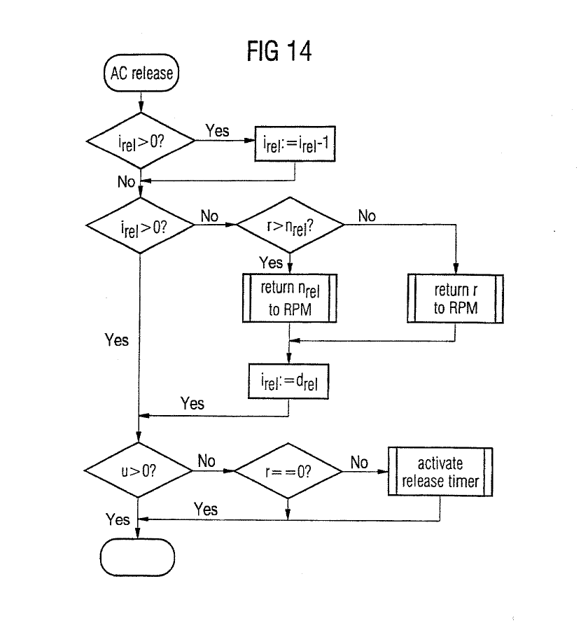

For the individual exemplary embodiments, the relatively concise terms introduced above are associated below with the individual embodiments as follows:

| Name | Embodiment |
|---|---|
| Leaky Share | FIGURE 2 + FIGURE 3 + FIGURE 4 |
| Adaptive Leaky share | FIGURE 12 + FIGURE 13 + FIGURE 14 |
| Retry Filter | |
| Adaptive Retry Filter | FIGURE 11 |

| | |
|---|---|
| Method for the dynamic regulation of | Leaky Share + Retry Filter |
| resource splitting in communications | |
| networks | |
| Method for the dynamic regulation of | Adaptive Watermark + Retry Filter |
| resource splitting in communications | or |
| networks with adaptive threshold | Adaptive Watermark + |
| values | Adaptive Retry Filter |
| Method for the dynamic regulation of | Adaptive Leaky Share + |
| resource splitting in communications | Adaptive Retry Filter |
| networks using a dynamic release | |
| rate | |

The illustration shown in FIG. 1 shows a detail from a larger IP network containing network nodes 1 to 5 which supports various transport services (with different QoS). For a particular transport service, 20 Mbps are reserved in this case for the connection between nodes 4 and 5. Traffic streams or data streams wishing to use these resources are controlled by a respective access control or admission control AC associated with the nodes 1, 2 and 3. Each AC module is complemented by a resource manager RSM (resource share manager).

Each RSM controls the resource allocation for the traffic stream which it represents and which is controlled by the associated AC. The RSM uses the interface to the AC to notify the AC of the available resources and, conversely, to receive the measured values required for resource control. If necessary, an RSM fetches further resources from the shared resource pool RP.

For this purpose, in this exemplary embodiment, the node 4 has an associated resource pool manager RPM which manages the shared resource pool RP. The RP contains the available resources. Initially, the RP contains the 20 Mbps to be split (available resources on the connection between nodes 4 and 5), and the resource share for each RSM is 0 Mbps.

During network operation, the RSMs fetch resources from the shared RP and return resources which are no longer required to said RP.

For the dynamic regulation of resource splitting in accordance with the invention, each of the two modules RSM and RPM now requires one method for allocating and one method for releasing resources:

RSM release: a method which decides whether and how many resources are returned to the RP. If required, uses the RPM release function to return resources to the RP (e.g. ‘Leaky Share’, or ‘Adaptive Leaky Share’).

RSM request: a method which decides whether and how many additional resources are requested from the RP. If required, uses the RPM request function to fetch resources from the RP (e.g. ‘Retry Filter’ or ‘Adaptive Retry Filter’).

RPM release: a method which, upon request, returns resources which are no longer required and places them in the managed RP.

RPM request: a method which, upon request, decides whether and how many resources are allocated to an RSM from the managed RP.

In accordance with a first embodiment of a method for the dynamic regulation of resource splitting in communications networks, the ‘Leaky Share’, the resource pool (RP) initially contains the resources which are to be split (e.g. a particular share of the capacity of a connecting line, such as between the two nodes 4 and 5). For each of the traffic streams competing for the pool, which are called RPSs (resource pool shareholder), a particular share, called RS (resource share), is taken from this RP and is allocated to the traffic stream.

Measured data are used, as described below, to make dynamic alignments as required by virtue of the RPSs involved returning resources which are not required to the shared RP, or greater shares being allocated to them from the shared RP.

For each RPS, the time profile of the resource requirement is measured (e.g. using the bandwidths of the AC requests and AC releases). If the resource requirement reaches a prescribed threshold value close to the allocated RS, its share is increased, provided that there are still unallocated resources available in the RP. If it is not possible to increase the RS, then only after a prescribed time period has elapsed is another check carried out to determine whether an increase is necessary (measured requirement has reached the threshold value) and possible.

Conversely, a particular portion of an RS is returned to the shared RP if it has not been required for a prescribed time period. If the shared RP is full at least up to a prescribed threshold value, however, the return is not made and another check is first carried out to determine whether the share to be returned is not required for a further time period of the prescribed length.

The text below illustrates the operations for the method described above in more detail with reference to a pseudo code of a programming language. For this purpose, the following parameters are used.

Parameter RSM

| | |
|---|---|
| r | allocated resources |
| u | current resource requirement |
| rₐ | resource requirement for the AC request under consideration |
| nᵣₑₗ | block size for resource release |
| dᵣₑₗ | delay for resource release in seconds |
| d_{req} | delay for resource requests |
| tᵣₑₗ | next possible time for a resource release |
| t_{req} | next possible time for a resource request |
| t | current time |
| Wₕ | threshold value for resource request |
| W₁ | threshold value for resource releases |
| n_{req} | block size for resource request |
| R | level in resource pool |
| Rₘₐₓ | threshold value for resource return |
| n_{req} | block size for resource requests |
| rₐ | resource requirement for the resource request or resource |
| | release under consideration |

The actions respectively taking place in an RSM and an RPM and described below are also shown in FIG. 2 to FIG. 7 in the manner below in the form of respective flowcharts, in particular for a software implementation.

Actions

| | | |
|---|---|---|
| RSM | release | FIGURE 2, FIGURE 3, FIGURE 4 |
| | request | |
| RPM | request | |
| | release | FIGURE 7 |

Processing in the RSM module:

Upon each AC request, the AC module notifies the RSM of the additionally required bandwidth rₐ and initiates the following processing:

if(u+rₐ³if (u+rₐ>wₕr AND t_{req}<t ) then request additional resources of size of n_{req}¹⁹ rₐ from RPM;

if (returned bandwidth b=0)

then t_{req}=t+d_{req};

else r→r+b;

Upon each accepted AC request, an AC module notifies the RSM of the additionally required bandwidth rₐ and initiates the following processing:

u→u+rₐ;

if(u>r−nᵣₑₗ) then tᵣₑₗ→tᵣₑₗ+dᵣₑₗ;

Upon each AC release, the AC module notifies the RSM of the bandwidth rₐ which is no longer required and initiates the following processing:

u→u−rₐ;

if(u<r−nᵣₑₗ AND tᵣₑₗ≦t )

then

offer RPM to give resources of size of nᵣₑₗ back to RP;

if( release was accepted ) then r→r−nᵣₑₗ;

tᵣₑₗ→tᵣₑₗ+dᵣₑₗ;

fi;

if(u=0) then activate a timer that triggers next resource release after dᵣₑₗ;

The Figures FIG. 2 to FIG. 4 show corresponding steps for an RSM in the form of flowcharts with the parameters shown above. FIG. 2 shows the activity of a Leaky Share in a resource management system RSM on the basis of the processing of an AC request, FIG. 3 shows the activity of a Leaky Share in an RSM on the basis of the processing of an AC release, and finally FIG. 4 shows the activity of a Leaky Share in an RSM on the basis of a call to the AC release method when an activated release timer runs out.

The illustration in FIG. 5 shows a reaction of a resource management system RSM to an AC request; if the share of used resources exceeds the threshold value wₕ, further resources are requested from the RP.

Processing in the RPM module:

For each resource request with additionally required bandwidth rₐ:

R→R−min(n_{req}rₐ,R);

return size of bandwidth assigned additionally, which is min(n_{req}rₐ,R);

For each resource release with offered bandwidth r_{b}:

if(R≧Rₘₐₓ)

then refuse release;

else accept release and set R→R+r_{b};

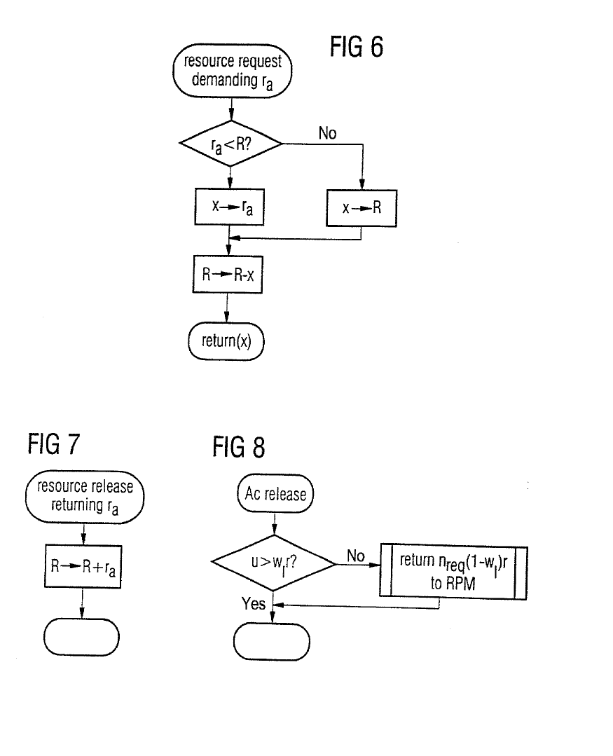

FIG. 6 shows corresponding processing of a resource request in a resource pool manager RPM, and FIG. 7 shows processing of a resource release in a resource pool manager RPM.

One variant of an RSM request involves the use of a ‘Retry Filter’. Differences exist merely in the operation of the RSM; the actions of the RPM remain unchanged. The associated actions are shown in FIG. 2 to FIG. 4 and FIG. 9 in the manner below in the form of respective flowcharts.

Actions

| | | |
|---|---|---|
| RSM | release | FIGURE 2, FIGURE 3, FIGURE 4 |
| | request | |
| RPM | request | |
| | release | FIGURE 7 |

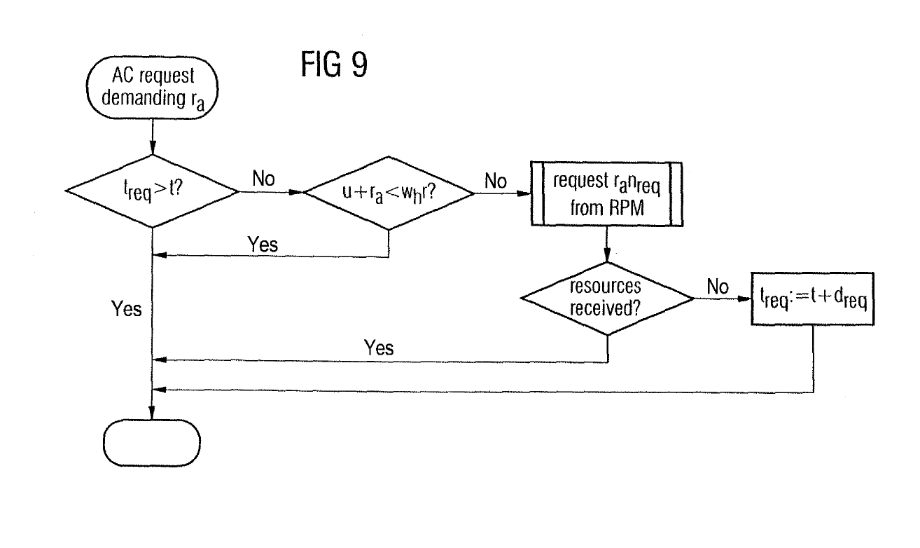

The illustration shown in FIG. 8 shows an appropriate reaction of a resource management system RSM to an AC release. If the share of used resources falls below the threshold value w₁, a portion of the resources which are not required is returned to the RP. FIG. 9 finally shows the processing of an AC request in the resource management system RSM for a Retry Filter.

To avoid synchronization, the time periods used can be differentiated by adding small random values.

An alternative embodiment is based on dynamic regulation of resource splitting in communications networks with adaptive threshold values.

For the resources to be split, e.g. a particular share of the capacity of a connecting line between the network nodes 4 and 5, a resource pool (RP) is likewise set up. From this resource pool, RSMs (resource share managers) can take resources for the traffic streams they represent as required, and, conversely, can return resources which are no longer required thereto. Each RSM again continuously checks, using measured data, first whether the allocated resources are able to cover the requirement and secondly whether it is possible to dispense with a portion of the allocated resources.

As soon as the measured bandwidth requirement reaches or falls below a second (lower) threshold value, the RSM returns a portion of the resources not required to the shared RP. The RSM automatically aligns this threshold value with the traffic load as follows:

If an RSM establishes that it is returning resources too often, then the threshold value is reduced. If an RSM establishes that it does not return any resources in a particular time interval, then the threshold value is increased.

The fundamental development in this context is the adaptation of the threshold value for the return of resources and the slowing-down of activity after an unsuccessful attempt to fetch additional resources from the shared RP.

The text below again gives a more detailed illustration of the operations for the method described above with adaptive threshold values, in the form of respective flowcharts. For this purpose, the following extended parameters are used:

Parameter RSM

| | |
|---|---|
| r | allocated resources |
| u | current resource requirement |
| rₐ | resource requirement for the AC request under consideration |
| wₕ | threshold value for resource request |
| wₗ | threshold value for resource releases |
| nᵣₑₗ | block size for resource release |
| iᵣₑₗ | length of the current measurement interval (for adaptation of wᵢ) in number |
| | of AC releases |
| i_{dec} | number of resource releases in the current measurement interval |
| m_{dec} | maximum value for resource releases in one measurement interval |
| lᵣₑₗ | duration of a measurement interval in number of AC releases |
| a_{inc} | step size for increases in w₁ |
| a_{dec} | step size for reductions in w₁ |
| i_{req} | number of AC requests |
| n_{req} | block size for resource request |

Parameter RPM

| | |
|---|---|
| R | level in resource pool |
| Rₘₐₓ | threshold value for resource return |
| n_{reg} | reqblock size for resource requests |
| rₐ | resource requirement for the resource request or resource release |
| | under consideration |

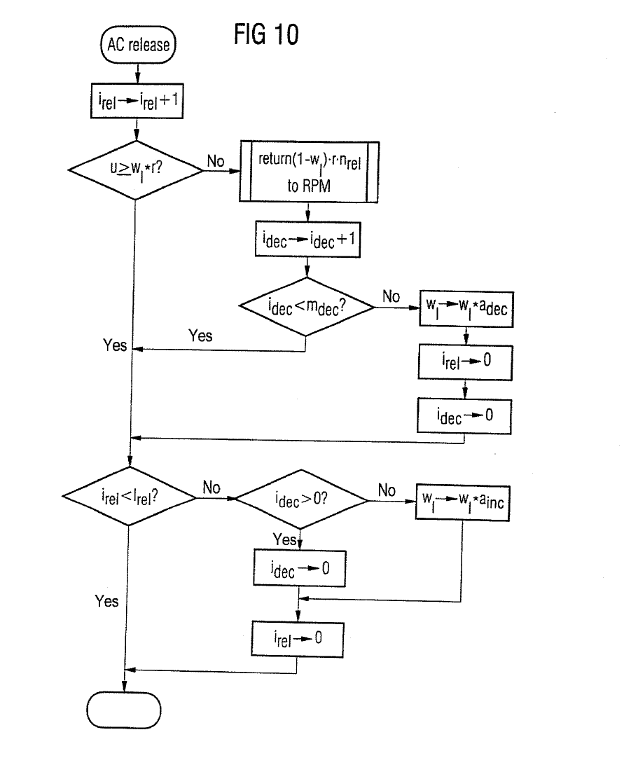

The actions respectively taking place in an RSM and an RPM with adaptive threshold values are also shown in FIG. 5 to FIG. 7 and in FIG. 10 in the manner below in the form of respective flowcharts.

Actions

| | | |
|---|---|---|
| RSM | release | |
| | request | |
| RPM | request | |
| | release | FIGURE 7 |

In this context, the illustration shown in FIG. 10 shows the fundamental steps for the activity of the Adaptive Watermark method in a resource management system RSM on the basis of processing of an AC request.

One variant of an RSM request in this regard involves the use of an ‘Adaptive Retry Filter’. Differences again exist only in the operation of the RSM; the actions of the RPM remain unchanged. The associated actions of the RSM are shown in FIG. 2 to FIG. 4 and FIG. 11 in the manner below in the form of respective flowcharts.

Actions

| | | |
|---|---|---|
| RSM | release | FIGURE 2, FIGURE 3, FIGURE 4 |
| | request | |
| RPM | request | |
| | release | FIGURE 7 |

FIG. 2 to FIG. 4 have already been described. The illustration shown in FIG. 11 shows the processing of an AC request in the resource management system RSM for an Adaptive Retry Filter.

Another advantageous alternative is based on dynamic regulation of resource splitting in communications networks using a dynamic release rate. For the resources which are to be split, the already known resource pool (RP) is set up. From this, RSMs (resource share managers) take resources for the traffic streams they represent as required and, conversely, return resources which are no longer required back thereto. Each RSM continuously uses measured data to check first whether the allocated resources are able to cover the requirement and secondly whether it is possible to dispense with a portion of the allocated resources.

If an RSM establishes that more resources are needed than are available to it, e.g. because the measured bandwidth requirement has reached or exceeded a threshold value, then it fetches additional resources from the shared RP, provided that it is not empty. If a resource increase is not possible on account of the RP being empty, it is possible to block any further demand for a particular time in order to avoid unnecessary load.

In order to establish whether it is possible to dispense with a portion of the allocated resources, the RSM continuously checks, whether a particular resource share is not required for a particular number of successive AC requests. Only then is this resource share returned.

One fundamental step involves the practice according to which a decision is made about the release of resources and according to which the activity is slowed down after an unsuccessful attempt to obtain more resources from the shared resource pool RP:

(a) If a particular resource share is not required for a sequence of directly successive AC requests having a particular length, then this share is returned. Following each return, the same method is used to check again whether it is possible to return a further share.

(b) If no AC requests arrive for a particular time period, e.g. the time period in which the checking sequence according to (a) could be expected, a particular resource share is returned as in (a).

(c) If an attempt to fetch additional resources from the shared RP fails, then further attempts to increase the resources are prevented until a particular number of directly successive AC requests have been received.

The text below again gives a more detailed illustration of the operations for the method described above with a dynamic release rate, in the form of respective flowcharts. For this purpose, the following parameters are used:

Parameter RSM

| | |
|---|---|
| r | allocated resources |
| u | current resource requirement |
| rₐ | resource requirement for the AC request under consideration |
| nᵣₑₗ | block size for resource release |
| dᵣₑₗ | delay for resource release in number of AC releases |
| iᵣₑₗ | minimum delay until the next resource release in number of |
| | AC releases |
| wₕ | threshold value for resource request |
| n_{req} | block size for resource request |

Parameter RPM

| | |
|---|---|
| R | level in resource pool |
| Rₘₐₓ | threshold value for resource return |
| n_{req} | block size for resource requests |
| rₐ | resource requirement for the resource request or resource |
| | release under consideration |

The actions respectively taking place in an RSM and an RPM with adaptive threshold values are also shown in FIG. 5 to FIG. 7 and in FIG. 12 to FIG. 14 in the manner below in the form of respective flowcharts.

Actions

| | | |
|---|---|---|
| RSM | release | FIGURE 12, FIGURE 13, FIGURE 14 |
| | request | |
| RPM | request | |
| | release | FIGURE 7 |

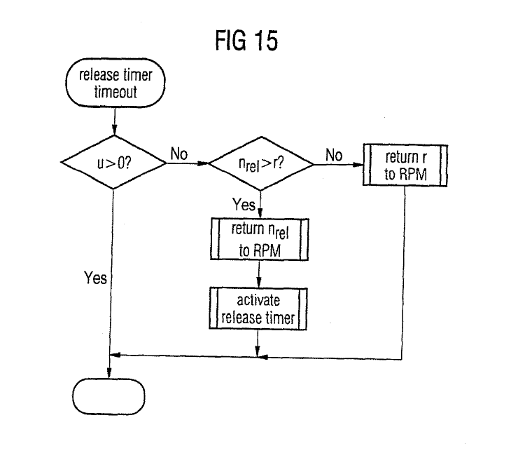

The illustration shown in FIG. 5 has already been explained. FIG. 12 now shows an example of the activity of an Adaptive Leaky Share in a resource management system RSM on the basis of the processing of an AC request. FIG. 13 shows this on the basis of the processing of an AC release for the activity of an Adaptive Leaky Share, and FIG. 14 finally shows a call to the AC release method for the activity of an Adaptive Leaky Share when an activated release timer runs out. FIG. 15 finally illustrates an alternative for the processing of a timeout for such a release timer in the RSM.

Simulations have shown that these methods operate reliably and are robust and simple to control.

In the RSM, each of the methods described above and shown in the figures can be used independently. Each of the release methods can, in theory, be combined with any of the request methods: e.g. ‘Leaky Share’ can be combined with ‘Retry Filter’ (cf. table above). The processing in the RPM is the same in all exemplary embodiments.

While preferred embodiments have been illustrated and described in detail in the drawings and foregoing description, the same is to be considered as illustrative and not restrictive in character, it being understood that only some embodiments have been shown and described and that all changes and modifications that come within the spirit of the invention both now or in the future are desired to be protected.

I claim as my invention:

1. A method for dynamic regulation of resource splitting over a plurality of data streams competing for the resources in a communications network, the resources to be split being made available in a resource pool from which, for each competing data stream, a resource share is taken and is allocated to this data stream, comprising the steps of:
dynamically aligning a resource requirement for a data stream on the basis that, if the resource requirement has arisen, a correspondingly greater resource share is allocated if possible or resources which are no longer required are returned to the resource pool, where
a resource share which is no longer required is returned to the resource pool if
the resource share has not been required for a prescribed number of successive resource inquiries or if
no new resource inquiries are received for a prescribed time period.

2. The method for the dynamic regulation of resource splitting over a plurality of data streams competing for the resources in a communications network of claim 1, where the prescribed time period is proportioned such that the prescribed number of successive resource inquires could be expected therein.

3. The method for the dynamic regulation of resource splitting over a plurality of data streams competing for the resources in a communications network of claim 1, where
if the resource requirement has arisen, an allocated resource share is increased, provided that there are still other resources available in the resource pool, or otherwise
further attempts to increase a resource share are prevented until a second prescribed number of successive resource inquiries has been received.

4. The method for the dynamic regulation of resource splitting over a plurality of data streams competing for the resources in a communications network of claim 1 where
if the resource requirement has risen, an allocated resource share is increased, provided that there are still other resources available in the resource pool, or otherwise further attempts to increase a resource share are prevented until the prescribed time period has elapsed.

5. The method for the dynamic regulation of resource splitting over a plurality of data streams competing for the resources in a communications network of claim 3, where the first and second prescribed numbers of successive resource inquiries adopt a same value.

6. The method for dynamic regulation of resource splitting over a plurality of data streams competing for the resources in a communications network of claim 1, where
a time profile is ascertained for the resource requirement of the data stream and is compared with a prescribed threshold value, where
the associated resource share is increased if there are still other resources available in the resource pool,
as soon as the resource requirement reaches or exceeds the threshold value.

7. The method for the dynamic regulation of resource splitting over a plurality of data streams competing for these resources in a communications network of claim 1 where
a resource share which is no longer required is returned to the resource pool only if
upon return there is no drop below a prescribed minimum value for the resource share.

8. An apparatus for dynamic regulation of resource splitting over a plurality of data streams competing for the resources in a communications network, comprising:
a resource pool for making available resources which are to be split and from which, for each competing data stream, a resource share can be taken and can be allocated to the data stream, where
a system for dynamically aligning the resource requirement for a data stream is provided which can be used, if the resource requirement has increased, to allocate a correspondingly greater resource share if possible or to return resources which are no longer required to the resource pool, where
a resource share which is no longer required can be returned to the resource pool if
the resource share has not been required for a prescribed number of successive resource inquiries or if
no new resource inquiries are received for a prescribed time period.

9. The apparatus for the dynamic regulation of resource splitting over a plurality of data streams competing for the resources in a communications network of claim 8, where the system for dynamically aligning the resource requirement can proportion the prescribed time period such that the prescribed number of successive resource inquiries could be expected therein.

10. The apparatus for the dynamic regulation of resource splitting over a plurality of data streams competing for the resources in a communications network of claim 8, where the system for dynamically aligning the resource requirement
can increase an allocated resource share when the resource requirement has risen, provided that there are still other resources available in the resource pool, or otherwise
can prevent further attempts to increase a resource share until a second prescribed number of successive resource inquiries has been received.

11. The apparatus for the dynamic regulation of resource splitting over a plurality of data streams competing for the resources in a communications network of claim 8 where the system for dynamically aligning the resource requirement
can increase an allocated resource share when the resource requirement has risen, provided that there are still other resources available in the resource pool, or otherwise
can prevent further attempts to increase a resource share until a prescribed time period has elapsed.

12. The apparatus for the dynamic regulation of resource splitting over a plurality of data streams competing for the resources in a communications network of claim 8, where the system for dynamically aligning the resource requirement
can ascertain a time profile for the resource requirement of the data stream and can compare it with a prescribed threshold value, where
the allocated resource share can be increased if there are still other resources available in the resource pool
as soon as the resource requirement reaches or exceeds the threshold value.
